(19) United States
(12) Patent Application Publication
(10) Pub. No.: US 2009/0225706 A1
(43) Pub. Date: Sep. 10, 2009

(54) METHOD FOR RESOURCE ALLOCATION OF TRANSMISSIONS IN A COMMUNICATION NETWORK EMPLOYING REPEATERS

(75) Inventors: Shyamal Ramachandran, Lake Mary, FL (US); Gerrit W. Hiddink, Utrecht (NL); Eugene Visotsky, Buffalo Grove, IL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/042,579

(22) Filed: Mar. 5, 2008

(51) Int. Cl. H04Q 7/00; H04J 3/08; H04B 7/14

(52) U.S. Cl. 370/329; 370/330; 370/315

(57) ABSTRACT

A communication network includes at least one base station, at least one relay station, and a plurality of subscriber stations. Within the communication network, a method for resource allocation of transmissions comprises: classifying each of a plurality of subscriber stations as one of a directly communicatively coupled subscriber station and an indirectly communicatively coupled subscriber station; scheduling transmissions of the directly communicatively coupled subscriber stations to a first time zone; and scheduling transmissions of the indirectly communicatively coupled subscriber stations to a second time zone.

### FIELD OF THE DISCLOSURE

The present disclosure relates generally to communication systems and more particularly to resource allocation of transmission in communication networks employing repeaters.

### BACKGROUND

IEEE 802.16 is a point-to-multipoint (PMP) system with one hop links between a base station (BS) and a subscriber station (SS). Such network topologies severely stress link budgets at the cell boundaries and often render the subscribers at the cell boundaries incapable of communicating using the higher-order modulations that their radios can support. Pockets of poor-coverage areas are created where high data-rate communication is impossible. This in turn brings down the overall system capacity. While such coverage voids can be avoided by deploying base stations tightly, this drastically increases both the capital expenditure (CAPEX) and operational expenditure (OPEX) for the network deployment. A cheaper solution is to deploy relay stations (RSs) (also known as relays or repeaters) in the areas with poor coverage and repeat transmissions so that subscribers in the cell boundary can connect using high data rate links.

The IEEE (Institute of Electrical and Electronics Engineers) 802.16 standards propose using an Orthogonal Frequency Division Multiple Access (OFDMA) for transmission of data over an air interface. (For this and any IEEE standards recited herein, see: http://standards.ieee.org/getieee802/index.html or contact the IEEE at IEEE, 445 Hoes Lane, PO Box 1331, Piscataway, N.J. 08855-1331, USA.) In an OFDMA communication system, a frequency bandwidth is split into multiple contiguous frequency sub-bands, or subcarriers, that are transmitted simultaneously. A user may then be assigned one or more of the frequency sub-bands for an exchange of user information, thereby permitting multiple users to transmit simultaneously on the different sub-carriers. These sub-carriers are orthogonal to each other, and thus intra-cell interference is minimized.

In Orthogonal Frequency-Division Multiple Access (OFDMA) systems, there occurs a noise amplification problem when using traditional radio frequency (RF) amplify-and-forward repeaters. Subscribers attached to the base station (BS) suffer from high amplified noise levels because repeaters amplify all sub carriers and not just the ones that have transmissions from subscribers attached to the repeater. This problem is especially pronounced on the uplink and prevents the successful detection of subscribers attached at the BS.

Accordingly, there is a need for system and method for resource allocation of transmissions in communication networks employing repeaters.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram illustrating a wireless communication network for use in the implementation of at least some embodiments.

FIG. 2 is a block diagram illustrating an alternative wireless communication network for use in the implementation of at least some embodiments.

FIG. 3 illustrates signal reception at a base station within the wireless communication networks of FIGS. 1 and 2 in accordance with some embodiments.

FIG. 4 is a flowchart illustrating a method for resource allocation of transmissions in a communication network employing repeaters in accordance with some embodiments.

FIG. 5 illustrates an example of the network implementation of the method of FIG. 4 in accordance with some embodiments.

FIG. 6 is a flowchart illustrating further detail of the method of FIG. 4 in accordance with some embodiments.

FIG. 7 illustrates the scheduling of transmissions in accordance with some embodiments.

FIG. 8 illustrates the scheduling of transmissions in accordance with some alternative embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present invention provides a method to distinguish between relayed and no-relayed flows in a communication network based on their relative delay. The segregation of flows is then used to assign orthogonal time zones for relayed and non-relayed subscribers. Specifically, the present invention provides a method to detect whether a subscriber station (SS) is attached directly to a base station (BS) or via a repeater and to segregate transmissions such that transmissions to SS attached directly to the BS and those attached via repeaters do not occur at the same time on different frequencies.

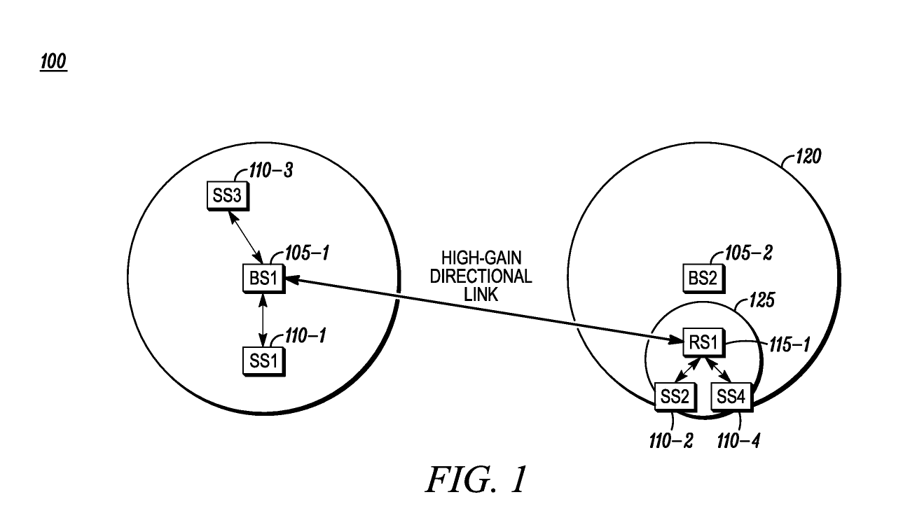

FIG. 1 illustrates a wireless communication network 100 for use in the implementation of at least some embodiments of the present invention. For example, the wireless communication network 100 can be an IEEE 802.16 network implementing the OFDMA physical layer (PHY). As illustrated, the wireless communication network 100 includes at least a first base station 105-1 and a second base station 105-2 for communication, either directly or indirectly with a plurality of subscriber stations 110-n (also known as mobile stations). In the wireless communication network as illustrated, for example, the first base station 105-1 is in direct communication with subscriber stations 110-1 and 110-3; and is further in indirect communication with subscriber stations 110-2 and 110-4 via a relay station 115-1 (also known as a repeater). In an embodiment of the present invention, the relay station 115-1 is an amplify-and-forward repeater. It will be appreciated by those of ordinary skill in the art that one relay station is shown in FIG. 1 for illustrative purposes only; and that any number of relays 115-n can be deployed within the wireless communication network 100 in the areas with poor coverage and relay transmissions so that subscriber stations 110-n in a cell boundary can connect using high data rate links. In some cases relays 115-n may also serve subscriber stations 110-n that are out of the coverage range of the base stations 105-n. In some networks, the relays 115-n are simpler versions of the base stations 105-n, in that they do not manage connections, but only assist in relaying data. Alternatively, the relays 115-n can be at least as complex as the base stations 105-n. Further, all or some of the relay stations 115-n can be deployed in a multi-hop pattern. In other words, some relays communicate with the base stations 105-n via other relays. Further, these relays can be within each other's coverage.

In operation, the first base station 105-1 operates on a radio frequency (RF) Channel 1, and the second base station 105-2 operates on a RF Channel 2. Relay station 115-1 is a repeater (amplify-and-forward type) which is operating on RF Channel 1, but located far away from the first base station 105-1 (or any other cell/sector operating on RF Channel 1). In the example of FIG. 1, the coverage holes 125 in the second base station's 105-2 cell 120, are served by relay station 115-1 amplifying and forwarding the first base station 105-1, which is distant from the coverage hole 125, and operating on a frequency channel other than the frequency channel at which the second base station 105-2 is operating. Detrimentally, if relay station 115-1 is located in the second base station's 105-2 cell 120 and amplifies and forwards the second base station's 105-2 traffic on the same channel, there will be interference. It will be appreciated by those of ordinary skill in the art that therefore having the relay station 115-1 operating on a different frequency than the second base station 105-2 is a precaution taken in the case of any amplify-and-forward repeater deployment to avoid interference in the base site and repeater cells.

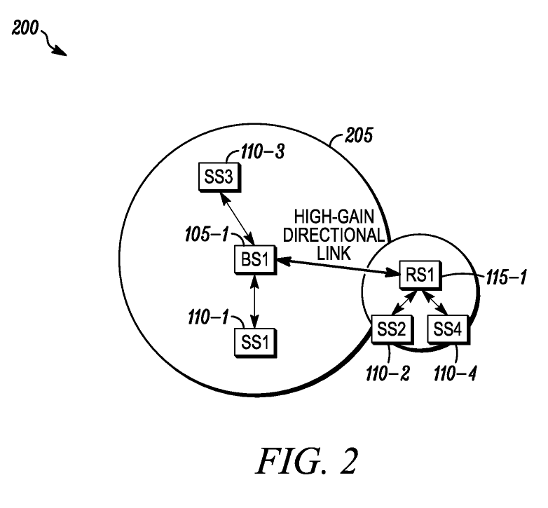

FIG. 2 illustrates an alternate example of a wireless communication network 200 for use in the implementation of at least some embodiments of the present invention. For example, the wireless communication network 200 can be an IEEE 802.16 network implementing the OFDMA PHY. As illustrated, the wireless communication network 200 includes at least the first base station 105-1 for communication, either directly or indirectly with a plurality of subscriber stations 110-n (also known as mobile stations). In the wireless communication network as illustrated, for example, the first base station 105-1 is in direct communication with subscriber stations 110-1 and 110-3; and is further in indirect communication with subscriber stations 110-2 and 110-4 via the relay station 115-1 (also known as a repeater). In an embodiment of the present invention, the relay station 115-1 is an amplify-and-forward repeater. Alternatively, the relays 115-n can be at least as complex as the base stations 105-n. In the example shown in FIG. 2, the relay station 115-1 is deployed on the edge of a cell 205 for range, capacity or coverage improvement. In this case the relay station 115-1 operates on the same frequency as the first base station 105-1 (RF Channel 1) and provides service improvement to two disadvantaged subscriber stations 110-2 and 110-4.

In OFDMA systems, transmission to/from different subscribers can occur at the same time as long as they occur on different sub-carriers. In other words, in an OFDMA system, a single OFDM symbol carries information for multiple subscribers.

Additionally, in some OFDMA systems (e.g. Worldwide Interoperability for Microwave Access (WiMax)), in order to attain frequency diversity, sub carriers are interleaved in frequency domain. Therefore each user's transmission, while occupying only a small fraction of the RF channel, is still spread across the entire RF channel bandwidth.

Given these OFDMA design constraints, there occurs a noise amplification problem when using traditional RF amplify-and-forward repeaters. This problem is especially pronounced on the uplink.

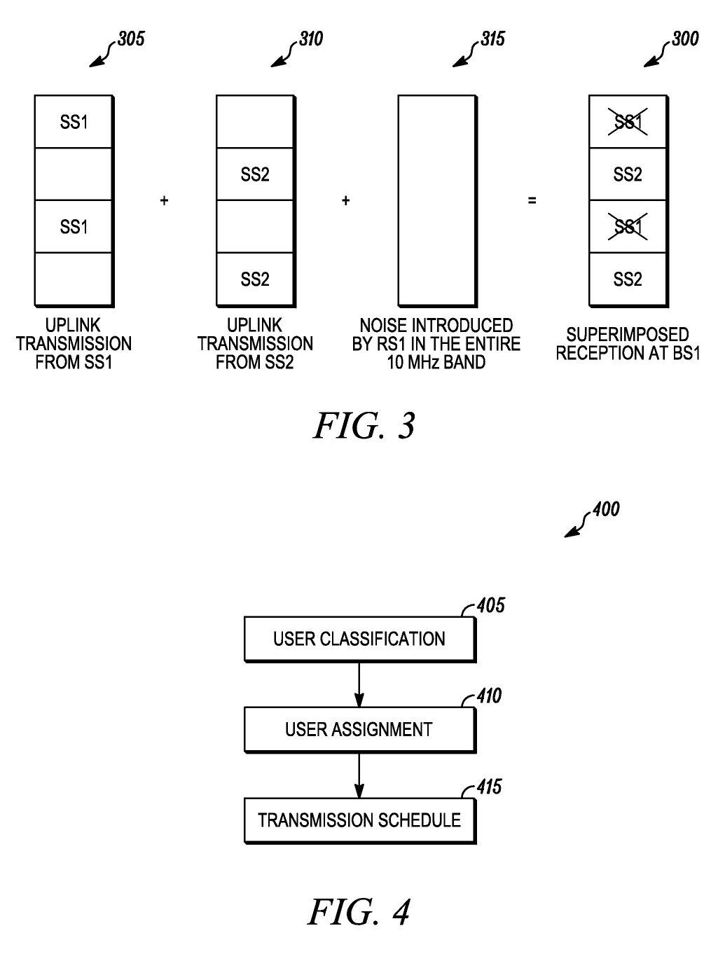

Consider the wireless communication systems 100 of FIG. 1 and 200 of FIG. 2 and assume that the relay station 115-1 is relaying uplink transmissions from subscriber station 110-2 towards the first base station 105-1. FIG. 3 illustrates signal reception 300 at the first base station 105-1 of various signals directly from subscriber station 110-1 (i.e. uplink transmission 305) and indirectly from subscriber station 110-2 via relay station 115-1 (i.e. uplink transmission 310). By virtue of simple amplify-and-forward operation, the relay station 115-1 amplifies the entire RF Channel 1. While the subcarriers occupied by subscriber station's 110-2 transmissions are amplified in a beneficial manner, the subcarriers unused by subscriber station 110-2 are carrying amplified noise 315. Should the first base station 105-1 be expecting to receive, say subscriber station 110-1, at the same time on the subcarriers not assigned to subscriber station 110-2 (since this is an OFDMA system), the first base station 105-1 may not be able to decode the transmissions from subscriber station 110-1 given the co-channel noise 315 introduced by the relay station 115-1 in the same sub carriers. Therefore, as illustrated in FIG.3, the final superimposed reception 300 at the first base station includes only the signals from subscriber station 110-2. In other words, transmissions from subscriber station 110-2 are still beneficially received at the first base station 105-1 since its useful signal and noise introduced on the first hop to the relay station 115-1 are both amplified. This, however, is not the case for subscriber station 110-1, as its useful power is not amplified by relay station 115-1 but nevertheless it suffers from noise enhancement due to the amplify-and-forward operation performed at relay station 115-1 across the entire channel bandwidth.

FIG. 4 is a flowchart illustrating a method 400 for resource allocation of transmissions in a communication network employing repeaters in accordance with some embodiments.

As illustrated in FIG. 4, the method 400 begins in Step 405 with User Classification. For example, referring to the networks of FIGS. 1 and 2, the first base station 105-1 attempts to determine which subscribers (i.e. subscriber stations 110-1 and 110-3) are communicatively coupled to it directly and which ones are communicatively coupled through repeaters such as relay station 115-1 (i.e. subscriber stations 110-2 and 110-4). In one implementation, the first base station 105-1 can determine which subscriber stations are directly and which are indirectly coupled to it using the propagation delay between itself and the subscribers. More specifically, this determination can be performed based on subscriber time-advance values obtained during the 802.16e ranging process.

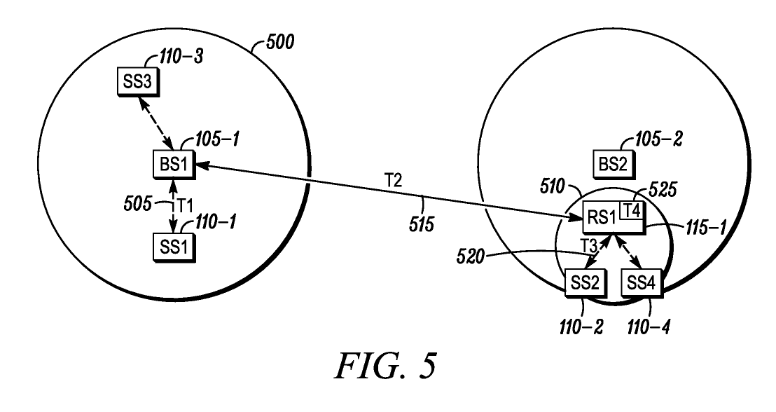

FIG. 5 illustrates an example of delay determination within the wireless communication network 100 of FIG. 1. As illustrated, a propagation delay between subscribers located in the first base station's 105-1 cell 500, such as the subscriber station 110-1 for instance, is of the order of value T1 505. The propagation delay between the first base station 105-1 and subscribers located in a repeater cell, such as the subscriber station 110-2 located in the relay station's 115-1 cell 510, is (T2 515+T3 520), where T2 515 is generally much larger than maximum possible T1 505 values. Furthermore, the amplify-and-forward operation may further involve an internal relay station processing delay, denoted as T4 525, so that the overall propagation delay between a subscriber served by a repeater and the BS is (T2 515+T3 520+T4 525). It is then highly likely that (T2 515+T3 520+T4 525) is much larger than T1 505 and subscribers being amplified through repeaters can be unambiguously identified at the first base station 105-1.

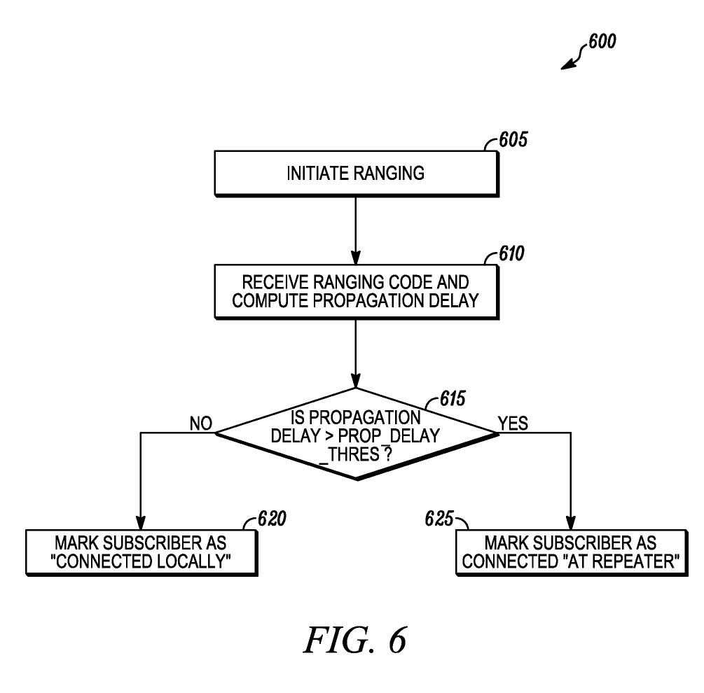

FIG. 6 is a flowchart illustrating a method 600 for identifying whether a subscriber is connected locally or via a repeater in accordance with an embodiment. As illustrated, the method begins with Step 605 in which the base station initiates ranging. Next, in Step 610, the base station receives a ranging code and computes the propagation delay between the base station and the subscriber station. The network can select a suitable threshold value, PROP_DELAY_THRES, based on base station cell site radius, repeater frequency reuse distance and internal relay station processing delay, and compare subscriber propagation delays against this threshold to determine if each subscriber station is attached locally or remotely through a repeater. As stated above, this determination can be made during a ranging procedure such as the one in IEEE 802.16e. In Step 615, the base station determines whether or not the propagation delay for the subscriber station is greater than the threshold value PROP_DELAY_THRES. When the propagation delay is less than the threshold value, the operation continues to Step 620 in which the subscriber station is identified as connected locally. When the propagation delay is greater than the threshold value PROP_DELAY_THRES, the operation continues to Step 625 in which the subscriber station is identified as connected via a repeater. It will be appreciated that the method of FIG. 6 can be repeated by the base station for a plurality of subscriber stations. Further, it will be appreciated that the method of FIG. 6 can be repeated for each of a plurality of base stations within a network communicating with each of a plurality of subscriber stations on a periodic basis to allow for a dynamically changing communication network.

Returning to FIG. 4, after Step 405, User Classification, the method continues with Step 410, User Assignment. Once the base station has made the classification of a subscriber station in one of the two categories, it schedules each of the subscriber stations intelligently in a manner such that transmissions to/from subscriber stations communicatively coupled through repeaters are not carried at the same time as transmissions to/from subscribers communicatively coupled directly. In other words, an OFDM symbol that carries transmissions to/from subscribers communicatively coupled locally should not carry transmissions to/from subscriber stations at relay sites. Thus, in Step 410, a transmission schedule is created taking into account the assignment in time zones of the two categories of subscriber stations.

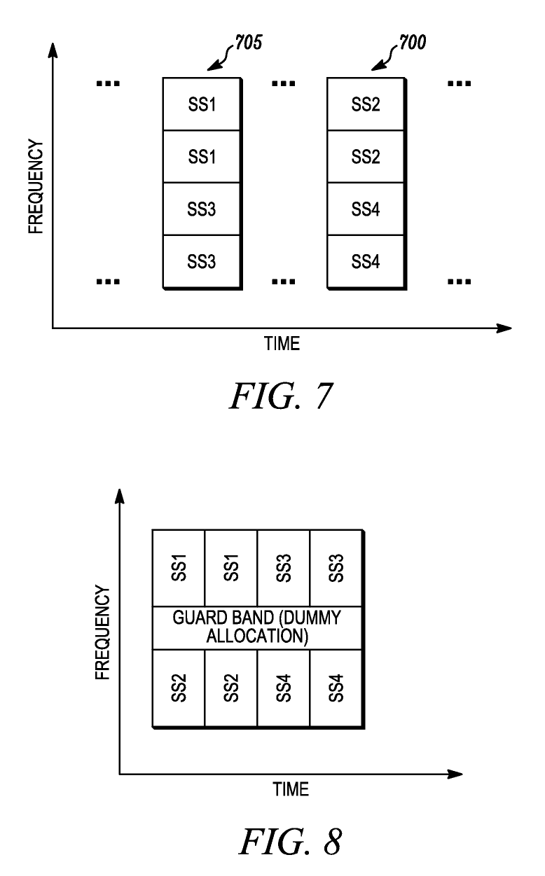

FIG. 7 illustrates the scheduling of transmissions in accordance with some embodiments. As illustrated in FIG. 7, transmissions to/from relay sites 700 (i.e. to/from subscriber station 110-2 and 110-4 via relay station 115-1) are scheduled in different time-domain zones than transmission to/from subscriber stations operating within the local base station cell 705 (i.e. subscriber stations 110-1 and 110-3). It will be appreciated by those of ordinary skill in the art that these zones can be as small as two OFDM symbols (a single WiMax Partial Usage of Subchannels (PUSC) zone) or as large as entire frames.

It will be appreciated that the scheduling procedure described herein will reduce interference at a base station. For example, a common amplify-and-forward repeater hardware implementation is to turn-on/turn-off amplify-and-forward operation based on the input Received Signal Strength Indication (RSSI) or other measure of input signal power. That is, if the input RSSI value is below some threshold, the repeater is off and it turns on once strength of the input signal exceeds the threshold. Hence, in the particular example of FIG. 7, the repeater 115-1 will be on during subscriber stations 110-2 and 110-4 transmissions but it will be in the off state during subscriber stations 110-1 and 110-2 transmissions. By keeping the repeater off, interference to subscriber stations 110-1 and 110-2 from relay station 115-1 is eliminated.

It will be appreciated by those of ordinary skill in the art that although the example illustrated herein described one repeater/relay station, the method can be generalized to a network comprising multiple repeaters. Using the same logic as above, users amplified through each repeater, if identified, are assigned in separate time zones to avoid cross-repeater interference.

In certain situations, subscriber station OFDMA allocations can be localized in frequency (for instance by following WiMax Adaptive Modulation and Coding (AMC) permutation scheme). In this case, following the User Classification step 405 of FIG. 4, users amplified through a repeater and users directly received at the base station can be assigned separate contiguous blocks of frequencies. An example of such an allocation is illustrated in FIG. 8. A repeater would then be directed only to pass frequencies corresponding to subscriber stations 110-2 and 110-4 transmissions. In another embodiment, a repeater may determine these frequencies autonomously. Finally, note that the scheduler may allocate a guard zone between the amplified and non-amplified bursts to allow for filter roll-off at the relay station. Such a guard zone can be simply created by not scheduling any users in a certain portion of the uplink/downlink subframe.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for resource allocation of transmissions in a communication network, the communication network comprising at least one base station, at least one relay station, and a plurality of subscriber stations, the method comprising:
classifying each of a plurality of subscriber stations as one of a directly communicatively coupled subscriber station and an indirectly communicatively coupled subscriber station;
scheduling transmissions of the directly communicatively coupled subscriber stations to a first time zone; and
scheduling transmissions of the indirectly communicatively coupled subscriber stations to a second time zone.

2. The method of claim 1, wherein the indirectly communicatively coupled subscriber stations are communicatively coupled through the at least one relay station to the base station.

3. The method of claim 1, wherein the classifying step comprises:
determining a propagation delay between each of the plurality of subscriber stations and the base station; and
classifying each of the plurality of subscriber stations based on its propogation delay.

4. The method of claim 1, wherein the classifying step comprises at the base station:
initiating ranging with each of the plurality of subscriber stations;
receiving a ranging code from each of the plurality of subscriber stations;
computing a propagation delay between the base station and each of the subscriber station;
determining whether or not the propagation delay for a subscriber station is greater than a threshold value;
classifying the subscriber station as a directly communicatively coupled subscriber station when the propagation delay is less than the threshold value; and
classifying the subscriber station as an indirectly communicatively coupled subscriber station when the propagation delay is greater than the threshold value.

5. The method of claim 4, wherein the threshold value is determined using on or more of a base station cell site radius, a relay station frequency reuse distance, and an internal relay station processing delay.

6. The method of claim 1, wherein the communication network operates using Orthogonal Frequency-Division Multiple Access (OFDMA), and further wherein the first time zone comprises at least a first OFDM symbol and the second time zone comprises at least a second OFDM symbol.

7. The method of claim 1, wherein the first time zone and the second time zone comprise contiguous frequency blocks.

8. The method of claim 1, further comprising:
repeating the classifying and scheduling steps for each of a plurality of base stations within the communication network.

9. The method of claim 1, further comprising:
repeating the classifying and scheduling steps on a periodic basis.

10. The method of claim 1, further comprising:
repeating the classifying and scheduling steps for each of a plurality of relay stations; and
scheduling separate time zones for each of the plurality of relay stations.

11. The method of claim 1, further comprising:
informing the relay station of the second time zone for amplification.

12. The method of claim 1, further comprising:
determining by the relay station the second time zone for amplification.

13. A method for resource allocation of transmissions in a communication network, the communication network comprising at least one base station, at least one relay station, and a plurality of subscriber stations, the method comprising:
classifying each of a plurality of subscriber stations as one of a directly communicatively coupled subscriber station and an indirectly communicatively coupled subscriber station;
assigning transmissions of the directly communicatively coupled subscriber stations to a first block of frequencies; and
assigning transmissions of the indirectly communicatively coupled subscriber stations to a second block of frequencies,
wherein the first block of frequencies and the second block of frequencies are contiguous.

14. The method of claim 13, wherein the indirectly communicatively coupled subscriber stations are coupled to the at least one base station via the at least one relay station, the method further comprising:
transmitting by the at least one relay station the second block of frequencies.

15. The method of claim 14, further comprising prior to the assigning steps:
determining the first block of frequencies and the second block of frequencies by the at least one relay station.

16. The method of claim 13, further comprising:
allocating a guard zone between the first block of frequencies and the second block of frequencies.

17. The method of claim 16, wherein the allocating of the guard zone comprises not scheduling any users in a certain portion of an uplink/downlink subframe.

18. The method of claim 13, wherein the classifying step comprises:
determining a propagation delay between each of the plurality of subscriber stations and the base station; and
classifying each of the plurality of subscriber stations based on its propagation delay.

19. The method of claim 13, wherein the classifying step comprises at the base station:
initiating ranging with each of the plurality of subscriber stations;
receiving a ranging code from each of the plurality of subscriber stations;
computing a propagation delay between the base station and each of the subscriber station;
determining whether or not the propagation delay for a subscriber station is greater than a threshold value;
classifying the subscriber station as a directly communicatively coupled subscriber station when the propagation delay is less than the threshold value; and
classifying the subscriber station as an indirectly communicatively coupled subscriber station when the propagation delay is greater than the threshold value.

20. The method of claim 13, wherein the threshold value is determined using on or more of a base station cell site radius, a relay station frequency reuse distance, and an internal relay station processing delay.
